(19) United States
(12) Patent Application Publication
(10) Pub. No.: US 2022/0122203 A1
(43) Pub. Date: Apr. 21, 2022

(54) ASSISTANCE REQUEST SYSTEM AND METHOD

(71) Applicant: IA9, INC., METHUEN, MA (US)

(72) Inventor: BLAISE J. COCO, Windham, NH (US)

(21) Appl. No.: 17/501,875

(22) Filed: Oct. 14, 2021

Related U.S. Application Data
(60) Provisional application No. 63/092,852, filed on Oct. 16, 2020.
(60) Provisional application No. 63/157,475, filed on Mar. 5, 2021.

(51) Int. Cl. G06Q 50/16; G06Q 30/00; G06F 3/0482

(52) U.S. Cl. CPC G06Q 50/16; G06F 3/0482; G06Q 30/018

(57) ABSTRACT

A method, computer program product, and computing system for receiving a request from a user for a real estate agent at a specific address; contacting a first pool of one or more qualified real estate agents chosen from a plurality of available real estate agents; awaiting a reply from the first pool of one or more qualified real estate agents; and contacting at least a second pool of one or more qualified real estate agents chosen from the plurality of available real estate agents if no reply is received from the first pool of one or more qualified real estate agents.

### RELATED APPLICATION(S)

This application claims the benefit of U.S. Provisional Application No. 63/092,852, filed on 16 Oct. 2020 and Provisional Application No. 63/157,475, filed on 5 Mar. 2021, the entire contents of which are incorporated herein by reference.

### TECHNICAL FIELD

This disclosure relates to assistance request systems and methods and, more particularly, to assistance request systems and methods for use in the real estate space.

### BACKGROUND

Oftentimes, when a professional is needed, it is difficult to locate one in a timely manner for the task at hand. Examples of such professionals may include but are not limited to real estate agents, contractors, carpenters, roofers, electricians, plumbers, landscapers, painters, gardeners, pool service providers, domestic help providers, connectivity providers, arborists, snow removal providers, gutter cleaning providers and junk removal providers.

For example, when you need such a professional in a timely manner, how do you know who to call? Especially if the professional service that you seek needs to be executed quickly. For example, if you are visiting an area in which you do not live and would quickly like to identify a local plumber that can perform work on a house you are interested in buying, how would you know who to reach out to?

### SUMMARY OF DISCLOSURE

In one implementation, a computer-implemented method is executed on a computing device and includes: receiving a request from a user for a real estate agent at a specific address; contacting a first pool of one or more qualified real estate agents chosen from a plurality of available real estate agents; awaiting a reply from the first pool of one or more qualified real estate agents; and contacting at least a second pool of one or more qualified real estate agents chosen from the plurality of available real estate agents if no reply is received from the first pool of one or more qualified real estate agents.

One or more of the following features may be included. The at least a second pool of one or more qualified real estate agents may include a third or more pools of one or more qualified real estate agents chosen from the plurality of available real estate agents. The at least a second pool of one or more qualified real estate agents may include the first pool of one or more qualified real estate agents. The specific address may include a manually-defined specific address. The specific address may include an automatically-defined specific address. Awaiting a reply from the first pool of one or more qualified real estate agents may include: awaiting a reply from the first pool of one or more qualified real estate agents for a defined period of time. The first pool of one or more qualified real estate agents may be defined, at least in part, upon one or more of: a geographic proximity of first pool of one or more qualified real estate agents with respect to the specific address; an agent rating of the pool of one or more qualified real estate agents; and an agent status of the pool of one or more qualified real estate agents. The plurality of available real estate agents may include: a plurality of prevetted real estate agents. The user may include a home buyer. The plurality of available real estate agents may include one or more of: a listing agent; and a selling agent.

In another implementation, a computer program product resides on a computer readable medium and has a plurality of instructions stored on it. When executed by a processor, the instructions cause the processor to perform operations including: receiving a request from a user for a real estate agent at a specific address; contacting a first pool of one or more qualified real estate agents chosen from a plurality of available real estate agents; awaiting a reply from the first pool of one or more qualified real estate agents; and contacting at least a second pool of one or more qualified real estate agents chosen from the plurality of available real estate agents if no reply is received from the first pool of one or more qualified real estate agents.

One or more of the following features may be included. The at least a second pool of one or more qualified real estate agents may include a third or more pools of one or more qualified real estate agents chosen from the plurality of available real estate agents. The at least a second pool of one or more qualified real estate agents may include the first pool of one or more qualified real estate agents. The specific address may include a manually-defined specific address. The specific address may include an automatically-defined specific address. Awaiting a reply from the first pool of one or more qualified real estate agents may include: awaiting a reply from the first pool of one or more qualified real estate agents for a defined period of time. The first pool of one or more qualified real estate agents may be defined, at least in part, upon one or more of: a geographic proximity of first pool of one or more qualified real estate agents with respect to the specific address; an agent rating of the pool of one or more qualified real estate agents; and an agent status of the pool of one or more qualified real estate agents. The plurality of available real estate agents may include: a plurality of prevetted real estate agents. The user may include a home buyer. The plurality of available real estate agents may include one or more of: a listing agent; and a selling agent.

In another implementation, a computing system includes a processor and memory is configured to perform operations including: receiving a request from a user for a real estate agent at a specific address; contacting a first pool of one or more qualified real estate agents chosen from a plurality of available real estate agents; awaiting a reply from the first pool of one or more qualified real estate agents; and contacting at least a second pool of one or more qualified real estate agents chosen from the plurality of available real estate agents if no reply is received from the first pool of one or more qualified real estate agents.

One or more of the following features may be included. The at least a second pool of one or more qualified real estate agents may include a third or more pools of one or more qualified real estate agents chosen from the plurality of available real estate agents. The at least a second pool of one or more qualified real estate agents may include the first pool of one or more qualified real estate agents. The specific address may include a manually-defined specific address. The specific address may include an automatically-defined specific address. Awaiting a reply from the first pool of one or more qualified real estate agents may include: awaiting a reply from the first pool of one or more qualified real estate agents for a defined period of time. The first pool of one or more qualified real estate agents may be defined, at least in part, upon one or more of: a geographic proximity of first pool of one or more qualified real estate agents with respect to the specific address; an agent rating of the pool of one or more qualified real estate agents; and an agent status of the pool of one or more qualified real estate agents. The plurality of available real estate agents may include: a plurality of prevetted real estate agents. The user may include a home buyer. The plurality of available real estate agents may include one or more of: a listing agent; and a selling agent.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an assistance request process according to an embodiment of the present disclosure;

FIG. 2 is a flowchart of the assistance request process of FIG. 1 according to an embodiment of the present disclosure;

FIGS. 3A-3E are diagrammatic views of screens rendered by the assistance request process of FIG. 1 according to an embodiment of the present disclosure;

FIG. 4 is another flowchart of the assistance request process of FIG. 1 according to an embodiment of the present disclosure; and

FIGS. 5A-5C are diagrammatic views of screens rendered by the assistance request process of FIG. 1 according to an embodiment of the present disclosure.

Like reference symbols in the various drawings indicate like elements.

### DETAILED DESCRIPTION OF THE PREFERRED EMBODIMENTS

System Overview

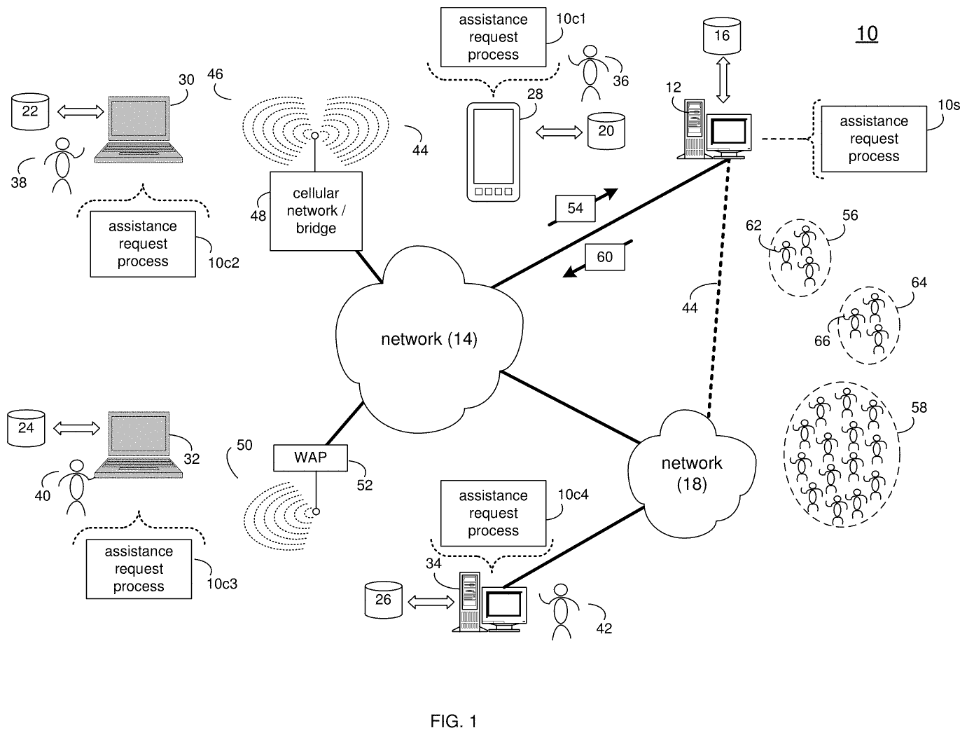

Referring to FIG. 1, there is shown assistance request process 10. Assistance request process 10 may be implemented as a server-side process, a client-side process, or a hybrid server-side/client-side process. For example, assistance request process 10 may be implemented as a purely server-side process via assistance request process 10s. Alternatively, assistance request process 10 may be implemented as a purely client-side process via one or more of assistance request process 10c1, assistance request process 10c2, assistance request process 10c3, and assistance request process 10c4. Alternatively still, assistance request process 10 may be implemented as a hybrid server-side/client-side process via assistance request process 10s in combination with one or more of assistance request process 10c1, assistance request process 10c2, assistance request process 10c3, and assistance request process 10c4. Accordingly, assistance request process 10 as used in this disclosure may include any combination of assistance request process 10s, assistance request process 10c1, assistance request process 10c2, assistance request process 10c3, and assistance request process 10c4.

Assistance request process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing platform.

The instruction sets and subroutines of assistance request process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of assistance request processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of assistance request processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), cloud-based storage and all forms of flash memory storage devices.

Examples of client electronic devices 28, 30, 32, 34 may include, but are not limited to, a smartphone 28, a personal digital assistant (not shown), a tablet computer (not shown), laptop computers 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access assistance request process 10 directly through network 14 or through secondary network 18. Further, assistance request process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, smartphone 28 and laptop computer 30 are shown wirelessly coupled to network 14 via wireless communication channels 44, 46 (respectively) established between smartphone 28 and laptop computer 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Assistance Request Process Overview

As will be discussed below in greater detail, assistance request process 10 may be configured to enable a user (e.g., user 36) to request assistance in the real estate space, wherein examples of such assistance may include but are not limited to assistance with real estate related services (such as the viewing of a property that is for sale) or assistance with obtaining professional providers (e.g., contractors, carpenters, roofers, electricians, plumbers, landscapers, painters, gardeners, pool service providers, domestic help providers, connectivity providers, arborists, snow removal providers, gutter cleaning providers and junk removal providers).

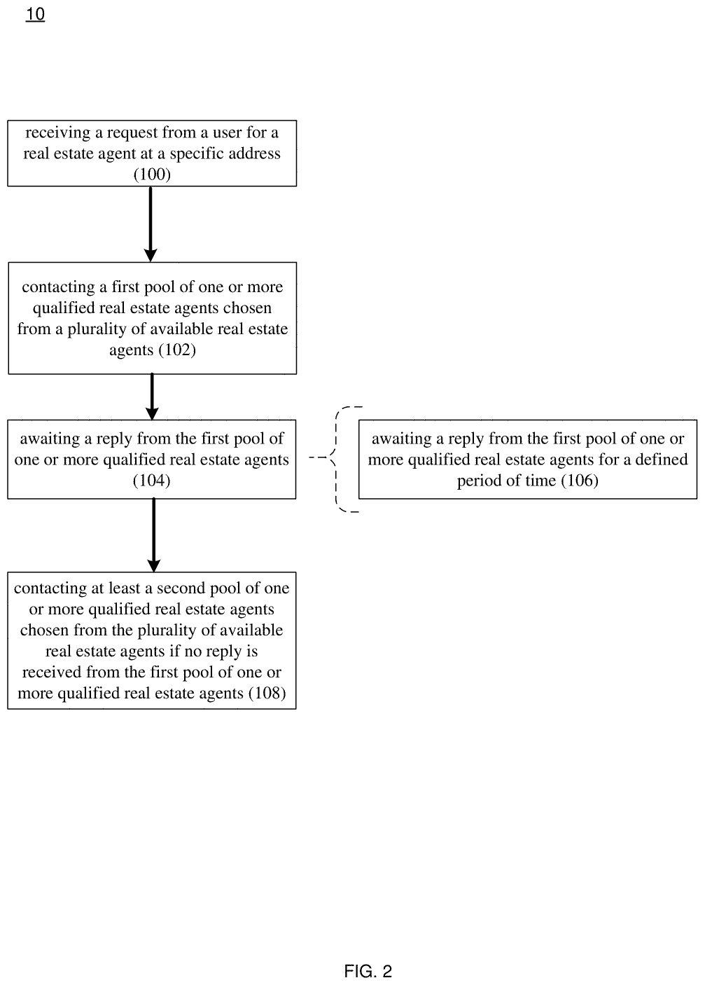

Referring also to FIG. 2. assistance request process 10 may receive 100 a request (e.g., request 54) from a user (e.g., user 36) for a real estate agent at a specific address (e.g., 1 Main Street, Bow, N.H. 03304). Example of the user (e.g., user 36) may include but is not limited to a home buyer, wherein this specific address (e.g., 1 Main Street, Bow, N.H. 03304) may include a manually-defined specific address or an automatically-defined specific address.

For example and with respect to a manually-defined address, user 36 may type the address (e.g., 1 Main Street, Bow, N.H. 03304) into assistance request process 10. Additionally/alternatively and with respect to an automatically-defined address, user 36 may use a GPS chipset (not shown) within smartphone 28 or cell tower triangulation to automatically-define the specific address (e.g., 1 Main Street, Bow, N.H. 03304), assuming that user 36/smartphone 28 are positioned proximate the specific address (e.g., 1 Main Street, Bow, N.H. 03304. Additionally/alternatively and with respect to an automatically-defined address, user 36 may use a camera (not shown) within smartphone 28 to e.g., scan a QR code included within a “for sale” sign to automatically-define the specific address (e.g., 1 Main Street, Bow, N.H. 03304).

For this example, assume that user 36 is walking past 1 Main Street in Bow, N.H., which is listed as being for sale. Further assume that user 36 is interested in viewing this property. Examples of such a property may include but are not limited to residential properties, commercial properties and industrial properties. Accordingly, assume that user 36 is interested in viewing 1 Main Street in Bow, N.H. Accordingly, user 36 may generate request (e.g., request 54), wherein assistance request process 10 may receive 100 request 54 from user 36 for a real estate agent at the specific address (e.g., 1 Main Street, Bow, N.H. 03304).

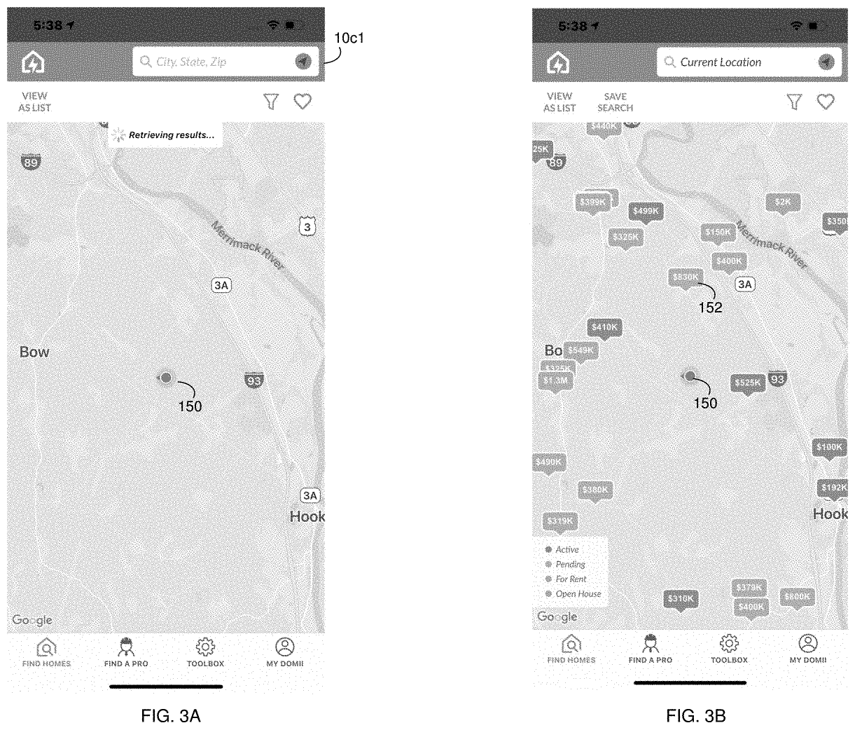

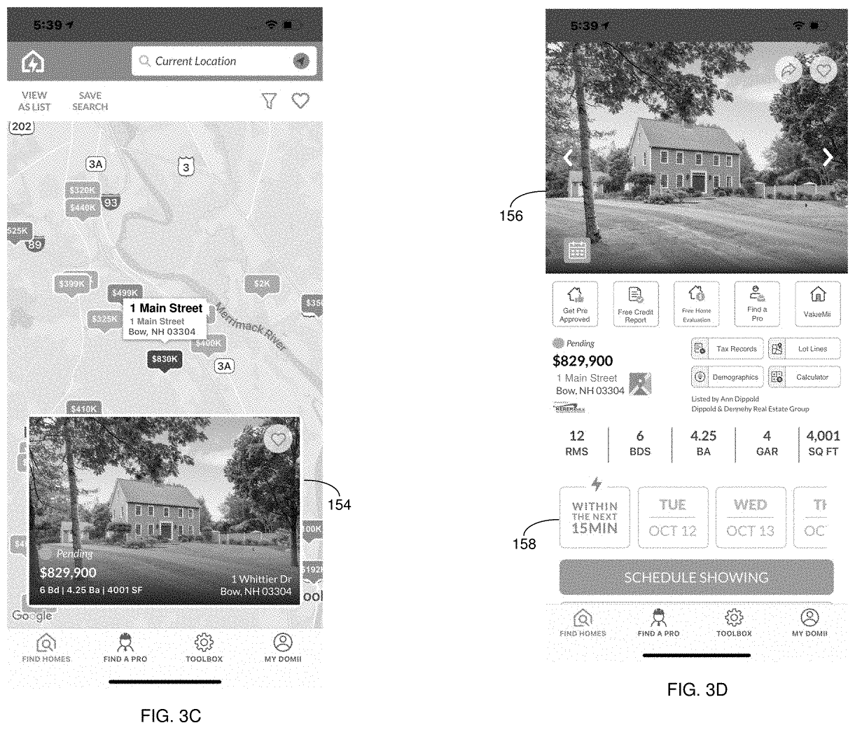

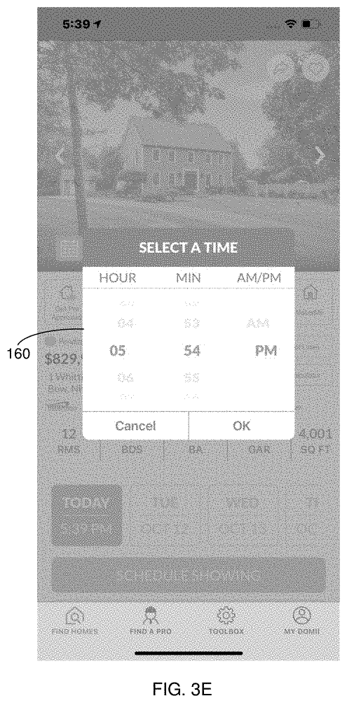

Specifically and referring also to FIG. 3A, user 36 my launch assistance request process 10 (e.g., via assistance request process 10c1 executed on smartphone 28) and may define the specific address (e.g., 1 Main Street, Bow, N.H. 03304), as indicated by location dot 150. As discussed above, this address may be manually-defined (e.g., by user 36 typing the address) or automatically-defined (e.g., via a GPS chipset/camera (not shown) within smartphone 28).

Once defined, assistance request process 10 may locate one or more available properties proximate the specific address (e.g., 1 Main Street, Bow, N.H. 03304), as shown in FIG. 3B. Assume for illustrative purposes that user 36 in interested in property 152. Accordingly, user 36 may select property 152, resulting in assistance request process 10 rendering summary window 154 as shown in FIG. 3C, which may provide cursory information (e.g., bedrooms, bathrooms, square footage, etc.) concerning property 152. In the event that user 36 is still interested, user 36 may select summary window 154, resulting in the rendering of detail window 156 as shown in FIG. 3D, which may provide more detailed information (e.g., rooms count, garage bays, etc.) concerning property 152.

Additionally and via detail window 156, user 36 may request a viewing of property 152. One of the viewing options may enable user 36 to request essentially an immediate viewing (e.g., “Within the next 15 minutes”). If user 36 selects “Within the next 15 minutes”, assistance request process 10 may render time selection window 160, as shown in FIG. 3E. Through time selection window 160, user 36 may select the specific time they wish to view property 152. In order to effectuate a viewing of property 156 so quickly, assistance request process 10 (e.g., via assistance request process 10c1 executed on smartphone 28) may generate request 54 that defines the specifics (e.g., location, time, date) of the requested viewing.

In response to receiving 100 request 54, assistance request process 10 may contact 102 a first pool of one or more qualified real estate agents (e.g., first pool 56) chosen from a plurality of available real estate agents (e.g., available pool 58). The plurality of available real estate agents (e.g., available pool 58) may include a plurality of prevetted real estate agents. For example, the administrators (not shown) of assistance request process 10 and/or a regulatory body (not shown) and/or a third-party (not shown) may regulate who may be a member of available pool 58 and the qualifications/requirements for admission to available pool 58.

As the intent of request 54 is to facilitate a viewing of property 152, the plurality of available real estate agents (included within available pool 58) may include one or more of: a listing agent (i.e., the agent that listed property 152 for sale); a selling agent (i.e., the agent that is selling property 152); or any other real estate professional capable of enabling a viewing of property 152.

The first pool of one or more qualified real estate agents (e.g., first pool 56) may be defined, at least in part, upon one or more of:
a geographic proximity of the pool of one or more qualified real estate agents (e.g., first pool 56) with respect to the specific address (e.g., 1 Main Street, Bow, N.H. 03304);
an agent rating of the pool of one or more qualified real estate agents (e.g., first pool 56); and
an agent status of the pool of one or more qualified real estate agents (e.g., first pool 56).

Geographic Proximity: When defining the pool of one or more qualified real estate agents (e.g., first pool 56), the current location of these one or more qualified real estate agents may be considered. As the intent of request 54 is to facilitate a viewing of property 152 essentially immediately (e.g., “Within the next 15 minutes), assistance request process 10 may contact 102 the real estate agents that are currently the closest to the specific address (e.g., 1 Main Street, Bow, N.H. 03304), since an agent that is currently e.g., one mile away from the specific address (e.g., 1 Main Street, Bow, N.H. 03304) is more likely to be able to provide an immediate viewing than an agent that is e.g., twenty miles away from the specific address (e.g., 1 Main Street, Bow, N.H. 03304).

Agent Rating: When defining the pool of one or more qualified real estate agents (e.g., first pool 56), the rating of the real estate agent may be considered. For example, assistance request process 10 may contact 102 only agents with at least a 4.5 star rating (e.g., out of a scale of 5 stars), wherein agents having less than a 4.5 star rating may be prohibited from being included within of the first pool of one or more qualified real estate agents (e.g., first pool 56), thus encouraging real estate agents to maintain high agent ratings by providing a high level of customer service.

Agent Status: When defining the pool of one or more qualified real estate agents (e.g., first pool 56), the status of the real estate agent may be considered. For example, assistance request process 10 may prioritize contacting 102 agents who have signed up for a “premier” program (in a fashion similar to the manner in which a search engine may prioritize search results based upon the status of the entities being searched).

Once assistance request process 10 contacts 102 the first pool of one or more qualified real estate agents (e.g., first pool 56) chosen from the plurality of available real estate agents (e.g., available pool 58), assistance request process 10 may await 104 a reply (e.g., reply 60) from the first pool of one or more qualified real estate agents (e.g., first pool 56). When awaiting 104 a reply (e.g., reply 60) from the first pool of one or more qualified real estate agents (e.g., first pool 56), assistance request process 10 may await 106 a reply from the first pool of one or more qualified real estate agents (e.g., first pool 56) for a defined period of time.

For example, assume that the first pool of one or more qualified real estate agents (e.g., first pool 56) includes one agent (e.g., agent 62). Assistance request process 10 may contact 102 this one agent (e.g., agent 62) included within the first pool of one or more qualified real estate agents (e.g., first pool 56), resulting in this one agent (e.g., agent 62) being e.g., audibly notified (e.g., via a doorbell sound) and/or visually notified (e.g., via a strobe flash) on a handheld device (not shown) used by agent 62. Assistance request process 10 may then await 106 a reply from the one agent (e.g., agent 62) included within the first pool of one or more qualified real estate agents (e.g., first pool 56) for the defined period of time (e.g., one minute).

In the event that the one agent (e.g., agent 62) included within the first pool of one or more qualified real estate agents (e.g., first pool 56) is available to effectuate the viewing of property 152 “within the next fifteen minutes”, this agent (e.g., agent 62) may accept the viewing and generate the reply (e.g., reply 60). In the event that the agent (e.g., agent 62) cannot accept the viewing, the agent (e.g., agent 62) may proactively decline (e.g., by saying they are unavailable) or passively decline (e.g., by not responding).

Assistance request process 10 may contact 108 at least a second pool of one or more qualified real estate agents (e.g., second pool 64) chosen from the plurality of available real agents (e.g., available pool 58) if no reply (e.g., reply 60) is received from the first pool of one or more qualified real estate agents (e.g., first pool 56).

Continuing with the above-stated example, assume that the one agent (e.g., agent 62) included within the first pool of one or more qualified real estate agents (e.g., first pool 56) is unavailable and, therefore, does not reply. Accordingly, assistance request process 10 may contact 108 at least a second pool of one or more qualified real estate agents (e.g., second pool 64) chosen from the plurality of available real agents (e.g., available pool 58).

Assume that the at least a second pool of one or more qualified real estate agents (e.g., second pool 64) includes one agent (e.g., agent 66). Assistance request process 10 may contact 108 this one agent (e.g., agent 66) included within the second pool of one or more qualified real estate agents (e.g., second pool 64), resulting in this one agent (e.g., agent 66) being e.g., audibly notified (e.g., via a doorbell sound) and/or visually notified (e.g., via a strobe flash) on a handheld device (not shown) used by agent 66.

Again, assistance request process 10 may then await a reply from the one agent (e.g., agent 66) included within the second pool of one or more qualified real estate agents (e.g., second pool 64) for a defined period of time (e.g., one minute) and then the process may repeat. Accordingly, the at least a second pool of one or more qualified real estate agents (e.g., second pool 64) may include a third or more pools of one or more qualified real estate agents (not shown) chosen from the plurality of available real estate agents (e.g., available pool 58). Additionally/alternatively, the at least a second pool of one or more qualified real estate agents (e.g., second pool 64) may include the first pool of one or more qualified real estate agents (e.g., first pool 56). Accordingly and in such a configuration, when assistance request process 10 contacts 108 second pool 64, the member(s) of first pool 56 may be contacted again.

In the event that the geographic proximity of the pools of one or more qualified real estate agents is considered when defining such pools, first pool 56 may be geographically closer to the specific address (e.g., 1 Main Street, Bow, N.H. 03304) than second pool 64, which may be the geographically closer to the specific address (e.g., 1 Main Street, Bow, N.H. 03304) than a third pool (not shown), which may be geographically closer to the specific address (e.g., 1 Main Street, Bow, N.H. 03304) than a fourth pool (not shown), and so on.

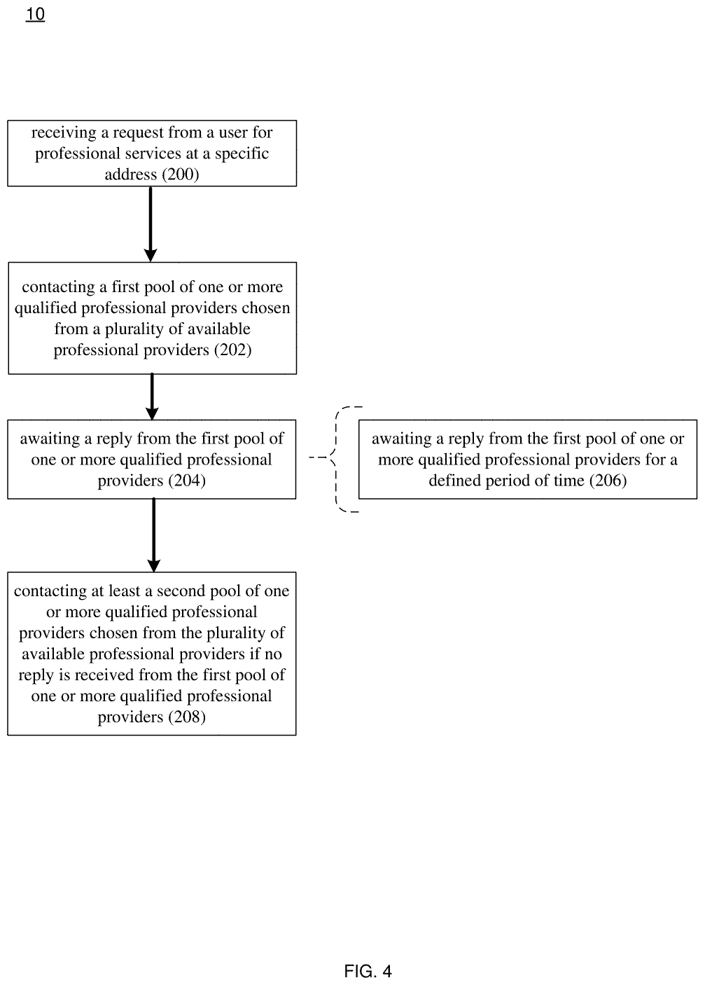

Referring also to FIG. 4, assistance request process 10 may be configured to provide assistance with more than just real estate agents. For example, assistance request process 10 may enable a user (e.g., user 36) to obtain professional providers (e.g., contractors, carpenters, roofers, electricians, plumbers, landscapers, painters, gardeners, pool service providers, domestic help providers, connectivity providers, arborists, snow removal providers, gutter cleaning providers and junk removal providers) to provide services at a specific address (e.g., 1 Main Street, Bow, N.H. 03304). Examples of the user (e.g., user 36) may include one or more of: a home buyer (e.g., a potential purchaser of property 152); a home seller (e.g., the seller of property 152); a listing agent (e.g., the real estate agent listing property 152); and a selling agent (e.g., the real estate agent selling property 152).

As discussed above, the specific address (e.g., 1 Main Street, Bow, N.H. 03304) may include a manually-defined specific address or an automatically-defined specific address. For example and with respect to a manually-defined address, user 36 may type the address (e.g., 1 Main Street, Bow, N.H. 03304) into assistance request process 10. Additionally/alternatively and with respect to an automatically-defined address, user 36 may use a GPS chipset (not shown) within smartphone 28 or cell tower triangulation to automatically-define the specific address (e.g., 1 Main Street, Bow, N.H. 03304), assuming that user 36/smartphone 28 are positioned proximate the specific address (e.g., 1 Main Street, Bow, N.H. 03304. Additionally/alternatively and with respect to an automatically-defined address, user 36 may use a camera (not shown) within smartphone 28 to e.g., scan a QR code included within a “for sale” sign to automatically-define the specific address (e.g., 1 Main Street, Bow, N.H. 03304).

Continuing with the above-stated example in which user 36 is walking past 1 Main Street in Bow, N.H., which (as discussed above) is listed as being for sale. Further assume that user 36 notices that this property (e.g., property 152) is in need of various professional services, such as landscaping and a roof replacement. Accordingly, user 36 may generate a request (e.g., request 54) for such professional services (e.g., landscaping and/or roofing), wherein assistance request process 10 may receive 200 the request (e.g., request 54) from the user (e.g., user 36) for these professional services at the specific address (e.g., 1 Main Street, Bow, N.H. 03304).

Specifically and referring again to FIG. 3A, user 36 my launch assistance request process 10 (e.g., via assistance request process 10c1 executed on smartphone 28) and may define the specific address (e.g., 1 Main Street, Bow, N.H. 03304), as indicated by location dot 150. As discussed above, this address may be manually-defined (e.g., by user 36 typing the address) or automatically-defined (e.g., via a GPS chipset/camera (not shown) within smartphone 28).

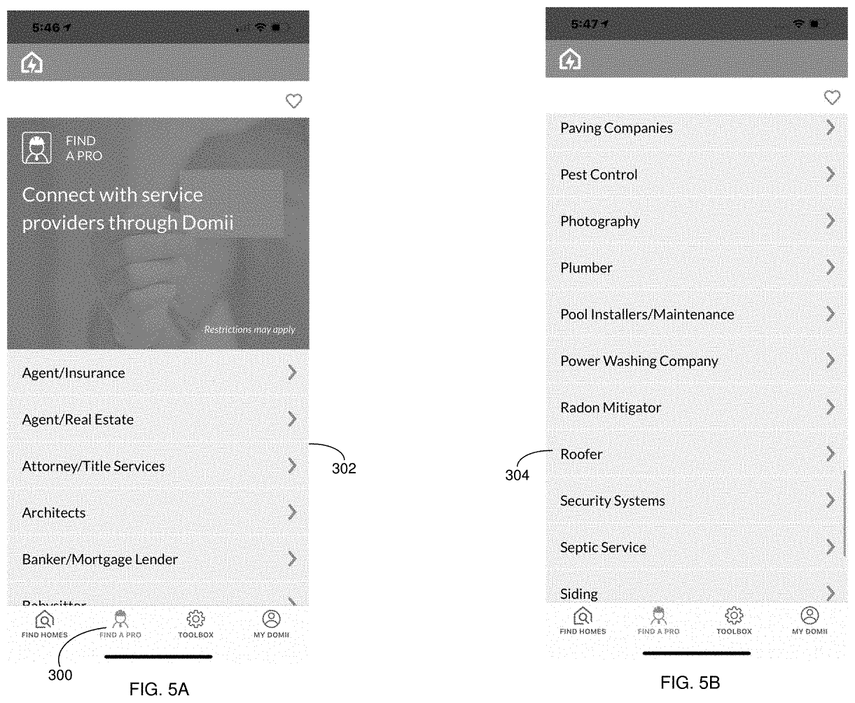

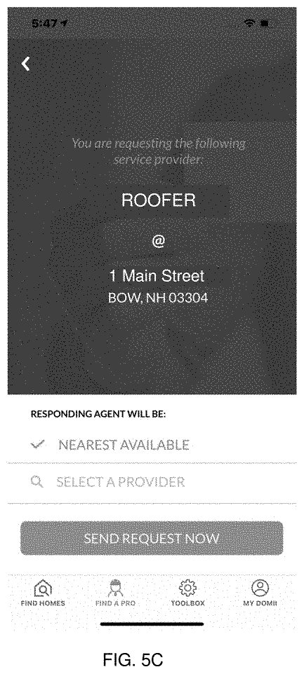

Once the specific address (e.g., 1 Main Street, Bow, N.H. 03304) is defined, user 36 may select “Find a Pro” tab 300, resulting in assistance request process 10 rendering a list of professional provider categories (e.g., list 302), as shown in FIG. 5A. User 36 may then scroll through the list of professional provider categories (e.g., list 302) to locate (in this example) the “roofer” category (e.g., category 304), as shown in FIG. 5B. User 36 may then select the “roofer” category (e.g., category 304), resulting in assistance request process 10 rendering confirmation window 306, as shown in FIG. 5C. Confirmation window 306 may enable user 36 to choose the “nearest available” professional provider or may enable user 36 to select a professional provider from a list of professional providers (i.e., roofers in this example). In order to enable user 36 to obtain such a professional provider (e.g., a roofer in this example), assistance request process 10 (e.g., via assistance request process 10c1 executed on smartphone 28) may generate request 54 that defines task specifics for the professional provider.

Assistance request process 10 may be configured to enable the user (e.g., user 36) to include additional information within request 54. For example, user 36 may be able to submit photographs and/or text-based information concerning the current (or desired) roof of property 152, thus enabling the potential professional provider to respond in a more thorough manner. For example and if sufficient information is provider, the professional provider (e.g., a roofer) may be able to provide an estimate concerning the cost of the desired service (e.g., a repair to an existing asphalt shingle roof, a new asphalt shingle roof, a new metal roof, a new slate roof, etc.).

In response to receiving 200 request 54, assistance request process 10 may contact 202 a first pool of one or more qualified professional providers (e.g., first pool 56) chosen from a plurality of available professional providers (e.g., available pool 58). The plurality of available professional providers (e.g., available pool 58) may include: a plurality of prevetted professional providers. For example, the administrators (not shown) of assistance request process 10 and/or a regulatory body (not shown) and/or a third-party (not shown) may regulate who may be a member of available pool 58 and the qualifications/requirements for admission to available pool 58.

As discussed above, the plurality of available professional providers (e.g., available pool 58) may include one or more of:
a plurality of contractors;
a plurality of carpenters;
a plurality of roofers;
a plurality of electricians;
a plurality of plumbers;
a plurality of landscapers;
a plurality of painters;
a plurality of gardeners;
a plurality of pool service providers;
a plurality of domestic help providers;
a plurality of connectivity providers;
a plurality of arborists;
a plurality of snow removal providers;
a plurality of gutter cleaning providers;
a plurality of junk removal providers.

Naturally, the above list is intended to be illustrative and not all inclusive. Accordingly, it is understood that other professional providers may be included in this list, examples of which may include but are not limited to: real estate agents, lawyers, doctors, accountants, and dentists.

The first pool of one or more qualified professional providers (e.g., first pool 56) may be defined, at least in part, upon one or more of:
a geographic proximity of the pool of one or more qualified professional providers (e.g., first pool 56) with respect to the specific address (e.g., 1 Main Street, Bow, N.H. 03304);
a provider rating of the pool of one or more qualified professional providers (e.g., first pool 56); and p1 a provider status of the pool of one or more qualified professional providers (e.g., first pool 56).

Geographic Proximity: When defining the pool of one or more qualified professional providers (e.g., first pool 56), the current location of these one or more qualified professional providers may be considered. Accordingly, assistance request process 10 may contact 202 the professional providers that are currently the closest to the specific address (e.g., 1 Main Street, Bow, N.H. 03304), since a professional provider that is currently e.g., one mile away from the specific address (e.g., 1 Main Street, Bow, N.H. 03304) is more likely to be able to handle the task at hand than a professional provider that is e.g., twenty miles away from the specific address (e.g., 1 Main Street, Bow, N.H. 03304).

Provider Rating: When defining the pool of one or more qualified professional providers (e.g., first pool 56), the rating of the professional provider may be considered. For example, assistance request process 10 may contact 202 only professional providers with at least a 4.5 star rating (e.g., out of a scale of 5 stars), wherein professional providers having less than a 4.5 star rating may be prohibited from being included within of the first pool of one or more qualified professional providers (e.g., first pool 56), thus encouraging professional providers to maintain high professional provider ratings by providing a high level of customer service.

Provider Status: When defining the pool of one or more qualified professional providers (e.g., first pool 56), the status of the professional provider may be considered. For example, assistance request process 10 may prioritize contacting 202 professional providers who have signed up for a “premier” program (in a fashion similar to the manner in which a search engine may prioritize search results based upon the status of the entities being searched).

Once assistance request process 10 contacts 202 the first pool of one or more qualified professional provider (e.g., first pool 56) chosen from the plurality of available professional provider (e.g., available pool 58), assistance request process 10 may await 204 a reply (e.g., reply 60) from the first pool of one or more qualified professional providers (e.g., first pool 56). When awaiting 204 a reply (e.g., reply 60) from the first pool of one or more qualified professional providers (e.g., first pool 56), assistance request process 10 may await 206 a reply (e.g., reply 60) from the first pool of one or more qualified professional providers (e.g., first pool 56) for a defined period of time.

For example, assume that the first pool of one or more qualified professional providers (e.g., first pool 56) includes one professional provider (e.g., professional provider 62). Assistance request process 10 may contact 202 this one professional provider (e.g., professional provider 62) included within the first pool of one or more qualified professional providers (e.g., first pool 56), resulting in this one professional provider (e.g., professional provider 62) being e.g., audibly notified (e.g., via a doorbell sound) and/or visually notified (e.g., via a strobe flash) on a handheld device (not shown) used by professional provider 62. Assistance request process 10 may then await 206 a reply from the one professional provider (e.g., professional provider 62) included within the first pool of one or more qualified professional providers (e.g., first pool 56) for the defined period of time (e.g., one minute).

In the event that the one professional provider (e.g., professional provider 62) included within the first pool of one or more qualified professional providers (e.g., first pool 56) is interested in the task at hand, this professional provider (e.g., professional provider 62) may accept the request (e.g., request 54) and generate the reply (e.g., reply 60). In the event that the professional provider (e.g., professional provider 62) is not interested in the task at hand, the professional provider (e.g., professional provider 62) may proactively decline (e.g., by saying they are not interested) or passively decline (e.g., by not responding).

Assistance request process 10 may contact 208 at least a second pool of one or more qualified professional providers (e.g., second pool 64) chosen from the plurality of available professional providers (e.g., available pool 58) if no reply (e.g., reply 60) is received from the first pool of one or more qualified professional providers (e.g., first pool 56).

Continuing with the above-stated example, assume that the one professional provider (e.g., professional provider 62) included within the first pool of one or more qualified professional providers (e.g., first pool 56) is unavailable and, therefore, does not reply. Accordingly, assistance request process 10 may contact 108 at least a second pool of one or more qualified professional providers (e.g., second pool 64) chosen from the plurality of available real agents (e.g., available pool 58).

Assume that the at least a second pool of one or more qualified professional providers (e.g., second pool 64) includes one professional provider (e.g., professional provider 66). Assistance request process 10 may contact 208 this one professional provider (e.g., professional provider 66) included within the second pool of one or more qualified professional providers (e.g., second pool 64), resulting in this one professional provider (e.g., professional provider 66) being e.g., audibly notified (e.g., via a doorbell sound) and/or visually notified (e.g., via a strobe flash) on a handheld device (not shown) used by professional provider 66.

Again, assistance request process 10 may then await a reply from the one professional provider (e.g., professional provider 66) included within the second pool of one or more qualified professional providers (e.g., second pool 64) for a defined period of time (e.g., one minute) and then the process may repeat. Accordingly, the at least a second pool of one or more qualified professional providers (e.g., second pool 64) may include a third or more pools of one or more qualified professional providers (not shown) chosen from the plurality of available professional providers (e.g., available pool 58). Additionally/alternatively, the at least a second pool of one or more qualified professional providers (e.g., second pool 64) may include the first pool of one or more qualified professional providers (e.g., first pool 56). Accordingly and in such a configuration, when assistance request process 10 contacts 208 second pool 64, the member(s) of first pool 56 may be contacted again.

In the event that the geographic proximity of the pools of one or more qualified professional providers is considered when defining such pools, first pool 56 may be geographically closer to the specific address (e.g., 1 Main Street, Bow, N.H. 03304) than second pool 64, which may be the geographically closer to the specific address (e.g., 1 Main Street, Bow, N.H. 03304) than a third pool (not shown), which may be geographically closer to the specific address (e.g., 1 Main Street, Bow, N.H. 03304) than a fourth pool (not shown), and so on.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a request from a user for a real estate agent at a specific address;
contacting a first pool of one or more qualified real estate agents chosen from a plurality of available real estate agents;
awaiting a reply from the first pool of one or more qualified real estate agents; and
contacting at least a second pool of one or more qualified real estate agents chosen from the plurality of available real estate agents if no reply is received from the first pool of one or more qualified real estate agents.

2. The computer-implemented method of claim 1 wherein the at least a second pool of one or more qualified real estate agents includes a third or more pools of one or more qualified real estate agents chosen from the plurality of available real estate agents.

3. The computer-implemented method of claim 1 wherein the at least a second pool of one or more qualified real estate agents includes the first pool of one or more qualified real estate agents.

4. The computer-implemented method of claim 1 wherein the specific address include a manually-defined specific address.

5. The computer-implemented method of claim 1 wherein the specific address include an automatically-defined specific address.

6. The computer-implemented method of claim 1 wherein awaiting a reply from the first pool of one or more qualified real estate agents includes:
awaiting a reply from the first pool of one or more qualified real estate agents for a defined period of time.

7. The computer-implemented method of claim 1 wherein the first pool of one or more qualified real estate agents is defined, at least in part, upon one or more of:
a geographic proximity of first pool of one or more qualified real estate agents with respect to the specific address;
an agent rating of the pool of one or more qualified real estate agents; and
an agent status of the pool of one or more qualified real estate agents.

8. The computer-implemented method of claim 1 wherein the plurality of available real estate agents includes:
a plurality of prevetted real estate agents.

9. The computer-implemented method of claim 1 wherein the user includes a home buyer.

10. The computer-implemented method of claim 1 wherein the plurality of available real estate agents includes one or more of:
a listing agent; and
a selling agent.

11. A computer program product residing on a computer readable medium having a plurality of instructions stored thereon which, when executed by a processor, cause the processor to perform operations comprising:
receiving a request from a user for a real estate agent at a specific address;
contacting a first pool of one or more qualified real estate agents chosen from a plurality of available real estate agents;
awaiting a reply from the first pool of one or more qualified real estate agents; and
contacting at least a second pool of one or more qualified real estate agents chosen from the plurality of available real estate agents if no reply is received from the first pool of one or more qualified real estate agents.

12. The computer program product of claim 11 wherein the at least a second pool of one or more qualified real estate agents includes a third or more pools of one or more qualified real estate agents chosen from the plurality of available real estate agents.

13. The computer program product of claim 11 wherein the at least a second pool of one or more qualified real estate agents includes the first pool of one or more qualified real estate agents.

14. The computer program product of claim 11 wherein the specific address include a manually-defined specific address.

15. The computer program product of claim 11 wherein the specific address include an automatically-defined specific address.

16. The computer program product of claim 11 wherein awaiting a reply from the first pool of one or more qualified real estate agents includes:
awaiting a reply from the first pool of one or more qualified real estate agents for a defined period of time.

17. The computer program product of claim 11 wherein the first pool of one or more qualified real estate agents is defined, at least in part, upon one or more of:
a geographic proximity of first pool of one or more qualified real estate agents with respect to the specific address;
an agent rating of the pool of one or more qualified real estate agents; and
an agent status of the pool of one or more qualified real estate agents.

18. The computer program product of claim 11 wherein the plurality of available real estate agents includes:
a plurality of prevetted real estate agents.

19. The computer program product of claim 11 wherein the user includes a home buyer.

20. The computer program product of claim 11 wherein the plurality of available real estate agents includes one or more of:
a listing agent; and
a selling agent.

21. A computing system including a processor and memory configured to perform operations comprising:
receiving a request from a user for a real estate agent at a specific address;
contacting a first pool of one or more qualified real estate agents chosen from a plurality of available real estate agents;
awaiting a reply from the first pool of one or more qualified real estate agents; and
contacting at least a second pool of one or more qualified real estate agents chosen from the plurality of available real estate agents if no reply is received from the first pool of one or more qualified real estate agents.

22. The computing system of claim 21 wherein the at least a second pool of one or more qualified real estate agents includes a third or more pools of one or more qualified real estate agents chosen from the plurality of available real estate agents.

23. The computing system of claim 21 wherein the at least a second pool of one or more qualified real estate agents includes the first pool of one or more qualified real estate agents.

24. The computing system of claim 21 wherein the specific address include a manually-defined specific address.

25. The computing system of claim 21 wherein the specific address include an automatically-defined specific address.

26. The computing system of claim 21 wherein awaiting a reply from the first pool of one or more qualified real estate agents includes:
awaiting a reply from the first pool of one or more qualified real estate agents for a defined period of time.

27. The computing system of claim 21 wherein the first pool of one or more qualified real estate agents is defined, at least in part, upon one or more of:
a geographic proximity of first pool of one or more qualified real estate agents with respect to the specific address;
an agent rating of the pool of one or more qualified real estate agents; and
an agent status of the pool of one or more qualified real estate agents.

28. The computing system of claim 21 wherein the plurality of available real estate agents includes:
a plurality of prevetted real estate agents.

29. The computing system of claim 21 wherein the user includes a home buyer.

30. The computing system of claim 21 wherein the plurality of available real estate agents includes one or more of:
a listing agent; and
a selling agent.
